(19) United States
(12) Patent Application Publication
(10) Pub. No.: US 2026/0044844 A1
(43) Pub. Date: Feb. 12, 2026

(54) POINT OF SALE CONTROLLING SYSTEM

(71) Applicant: TOSHIBA GLOBAL COMMERCE SOLUTIONS, INC., Durham, NC (US)

(72) Inventors: Kimberly WOOD, Durham, NC (US); Suzanne M. BLEAKLEY, Durham, NC (US); Jonathan E. SIMMONS, Durham, NC (US)

(73) Assignee: TOSHIBA GLOBAL COMMERCE SOLUTIONS, INC., Durhan, NC (US)

(21) Appl. No.: 18/799,599

(22) Filed: Aug. 9, 2024

(51) Int. Cl. G06Q 20/20; G07G 1/00

(52) U.S. Cl. CPC G06Q 20/208; G07G 1/0072

(57) ABSTRACT

Methods and systems of a point of sale controlling system are disclosed. In some aspects, a first item is scanned and the weight of the first item is verified. In response to the weight of the first item being verified, the following occurs: a counter is incremented by a first amount associated with the first item; a second item is scanned while the first item remains on the weighting system, a weight of the first and second items on the weighting system is verified; in response to the weight of the first and second items being verified, a triggering event using the counter is determined to have occurred; in response to determining that the triggering event has occurred, all items on the weighting system is moved to a bagging area and resetting the counter; otherwise all items remain on the weighting system and additional items can be scanned and weighed.

### BACKGROUND

Self-checkout counters have grown in popularity. They allow stores to save labor costs, and allow users to have more flexibility and possibly check out quickly instead of waiting in line for an employee of the store to check out. The more efficient each self-checkout counter is, the better these machines will be to customers and retailers/stores.

### BRIEF DESCRIPTION OF THE DRAWINGS

The objects and features of the present disclosure can be better understood with reference to the drawings described below, and the claims. The drawings are not necessarily to scale, emphasis instead generally being placed upon illustrating the principles of embodiments of the present disclosure. In the drawings, like numerals are used to indicate like parts throughout the various views.

FIG. 1 illustrates a perspective physical view of a point-of-sale system in accordance with some embodiments.

FIG. 2 illustrates a diagrammatic view of the point-of-sale system of FIG. 1 in accordance with some embodiments.

FIG. 3 illustrates a method of operating a point-of-sale system in accordance with one embodiment.

FIG. 4 illustrates a method of operating a point-of-sale system in accordance with another embodiment.

### DETAILED DESCRIPTION OF THE EMBODIMENTS

Some self-checkout (“SCO”) systems (also known as “conveyor bagging systems” or “belted SCOs”) each include a conveyor belt and a bagging area. These self-checkout systems may each include two main areas. The first area of the self-checkout system is closest to where the customer scans the item (e.g., via scanning bar codes). This is called the security section, which is a belted portion with scales underneath that are used to verify the weight of the item. The second area of the self-checkout system is the transport/bagging area, which includes a conveyor belt responsible for receiving validated items from the security section and moving them to the bagging area.

In one embodiment, the order of operations in belted SCO with weight security is to first scan the item, place it on the belt, verify the weight of the item, and if verified, the item moves down the belt to the bagging area. Unfortunately, this sequence can cause awkwardness for the customer as the system will force the customer to pause for each item as the weight is verified and while the item moves down the conveyor belt from the weighing area so the next item can be scanned. If the customer is quick and scans the next item before the previous item's weight is verified and moved away from the weighing area, they may be prompted to pick up the last item that was placed in the security area because the system thinks this newly scanned item is too heavy. In this regard, the customer is delayed by the time that each weight-verified item has to move away the weighing belt before scanning the next item.

To address the above situation, the present disclosure provides a point-of-sale controlling system while allows for a customer to efficiently and quickly check out using the SCO.

Generally, according to some embodiments of this disclosure, such point-of-sale systems batch the security verification function using the following order of operations: the customer scans an item, the customer places the item scanned on the weighing belt, weight security is verified for all items on the belt (adding the expected weights of all items expected on the weighing belt), and then the customer immediately scans the next item. This process repeats until the weight security zone reaches one of three states: 1—number of items reaches a threshold, 2—the total weight on the belt reaches a threshold, or 3—a manual purge act by the customer or service attendant. Once one of the conditions for the current batch of items is reached, the belt motors will be engaged and all items on the weighing belt will be moved as a group to the bagging area. This improves efficiency by reducing the lag time required while security is verified and an individual item is moved from the security area. It also makes the flow more natural for someone accustomed to scanning on belted lanes without weight security implemented. This will also allow an opportunity for the next customer in line to begin scanning items and not have them mixed with a customer who may still be bagging items in the bagging area. To implement this idea, a software update would be needed, where the starting section of the conveyor would essentially be used like a medium bagger accepting items until that zone is populated. Then the weight validation would occur before moving the items further down the conveyor. This method could be implemented as an option and allow individual stores to select the best option that suits their needs.

Various examples of the present disclosure will now be described. The following description provides specific details for a thorough understanding and enabling description of these examples. One skilled in the art will understand, however, that the present disclosure may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the present disclosure. Certain terms may even be emphasized below; however, any terminology intended to be interpreted in any restricted manner will be overtly and specifically defined as such in this Detailed Description section.

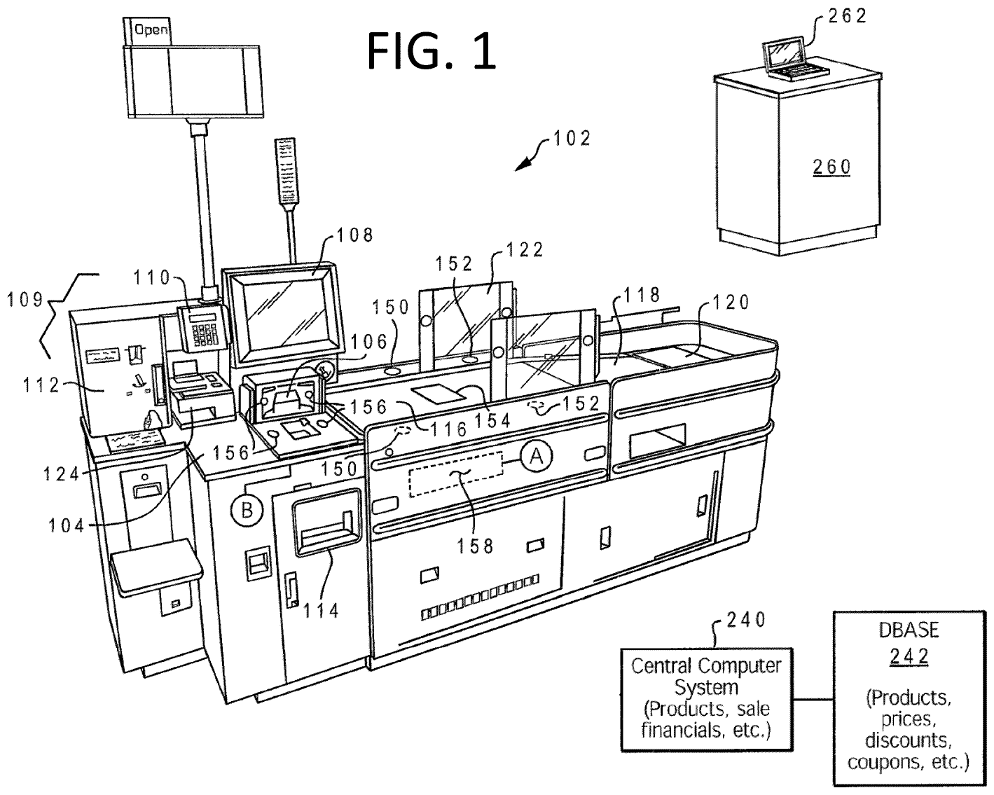

With reference now to the figures, and in particular FIG. 1, there is illustrated an exemplary embodiment of a self-checkout system (and self-checkout system environment) within which the features of the present disclosure are implemented. It should be noted that the various components and specific configuration provided by FIG. 1 is provided solely for illustration and not meant to imply any limitation on the actual self-checkout system within which the features of the present disclosure are applied/implemented.

FIG. 1 is a schematic diagram representation of an exemplary self-checkout system equipped with a verification mark dispenser and verification mark detectors according to one embodiment. Self-checkout system 102 comprises counter 104, universal product code (“UPC”) reader (or scanner) 106, and display 108 for interactive customer communication.

Self-checkout system 102 further comprises payment mechanism 109, which includes credit card reader 110, cash acceptor 112, cash dispenser 114 and/or a receipt unit 124. Further, self-checkout system comprises an entry conveyor 116, an out-feed conveyor 118, a bagging area 120, and/or a tunnel 122.

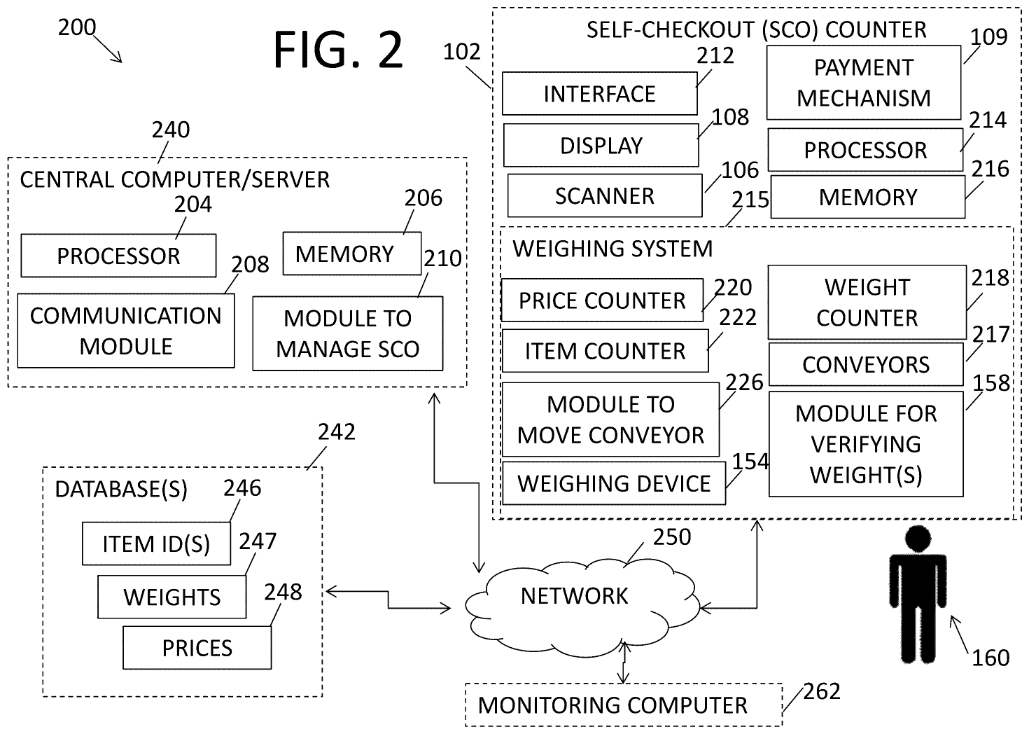

One of skill in the art will appreciate that the self-checkout device may include, for example, a computer system which controls the overall operation of the self-checkout device. Such a computer system may include, for example, a processor, memory (RAM and/or ROM), data storage devices (hard drives, removable storage devices, floppy drives, etc.), input devices (keyboard, microphone, trackpad, bar-code reader, UPC scanner, magnetic card reader, mouse, RF tag reader, touch screen and the like), audio system, and the like. The computer system may be in communication with one or more devices that together form the self-checkout system and/or self-checkout device. The computer system and the SCO is described in more detail FIG. 2.

Moreover, in a retail environment, the self-checkout system 102 is connected/linked with a central computer system 240 (which represents a BOSS controller and a Point-Of-Sale (POS) Controller), which is discussed in more depth in FIG. 2. Additionally, the verification mechanisms (such as weighing system 158) of self-checkout system 102 are linked to the computer device 262 of the customer assistant at the monitoring station 260.

The BOSS controller of central computer system 240 manages database 242, which includes information relating to the security aspects of the products: volume, weight, dimensions, and the like. The POS controller manages the point-of-sale functions of the self-checkout (and other cashier operated) systems, and also manages the pricing database for product.

It should be noted that the self-checkout system 102 may further include various other features, such as one or more sensors, cameras, lasers/LEDs, activators, or the like 156 to properly identify one or more features (e.g., height, weight, appearance, etc.) of the item being scanned, which may be located adjacent/proximate to the UPC reader 106.

Moreover, there may be additional devices 152 to assist in weighing, locating, etc. the item on the weighing device 154. It, thus, should be understood that the present disclosure should not be limited to the embodiments shown in the FIGs.

One of skill in the art will also appreciate that the present disclosure may be used with any self-checkout device including a self-checkout lane having, for example, conveyor belts, stationary self-checkout systems, and any other self-checkout systems which generally include a register system and associated security devices.

The above described and illustrated self-checkout system 102 may be utilized with a security system which uses the known weight of each item to help protect against customer fraud.

In one embodiment, a weighing system is thus illustrated in FIG. 1 which may include a weighing device 154, which works with entry conveyor 116 and/or out-feed conveyor 118. In this regard, the customer scans a first item (not shown), places the item on the entry conveyor 116 which transports the scanned first item to the weighing device 154, the weight of the scanned first item is then verified using system 158, and if verified, the system 158 will direct the first item to move down to the bagging area 120 from the weighing device 154 using the out-feed conveyor 118. If, when the customer scans a first item and the item is on the weighing device 154, the weight of the scanned first item is not verified, the system 158 will notify both the customer on the display 108 and/or notify the computer device 262 of a customer assistant at a monitoring station 260 of a deviation between the expected weight and the measured weight of the scanned first item. Then, at this point, according to previous systems, the first item will not be allowed to move to the bagging area 120 and the next item will not be allowed to be scanned until this error is resolved. This previous embodiment is for security purposes so that the customer does not take an item that was accidentally or purposefully not scanned (or some other error or issue). Other security methods for preventing customer fraud in a self-checkout system may be used along with those provided by the present disclosure.

As mentioned above, according to previous systems, each item is separately measured on the weighing device 154 and is moved down the out-feed conveyor belt 118 before the next item can be scanned. However, some embodiments of the present application are directed to keeping the scanned first item on the weighing conveyor belt 154 and immediately and directly allowing the customer to scan and place next items (a second item and subsequent items) on the weighing conveyor belt 154 along with the first item before the first item is moved down the weighing conveyor belt 154 to the bagging area 120. Such embodiments are discussed below with regard to FIGS. 2-4.

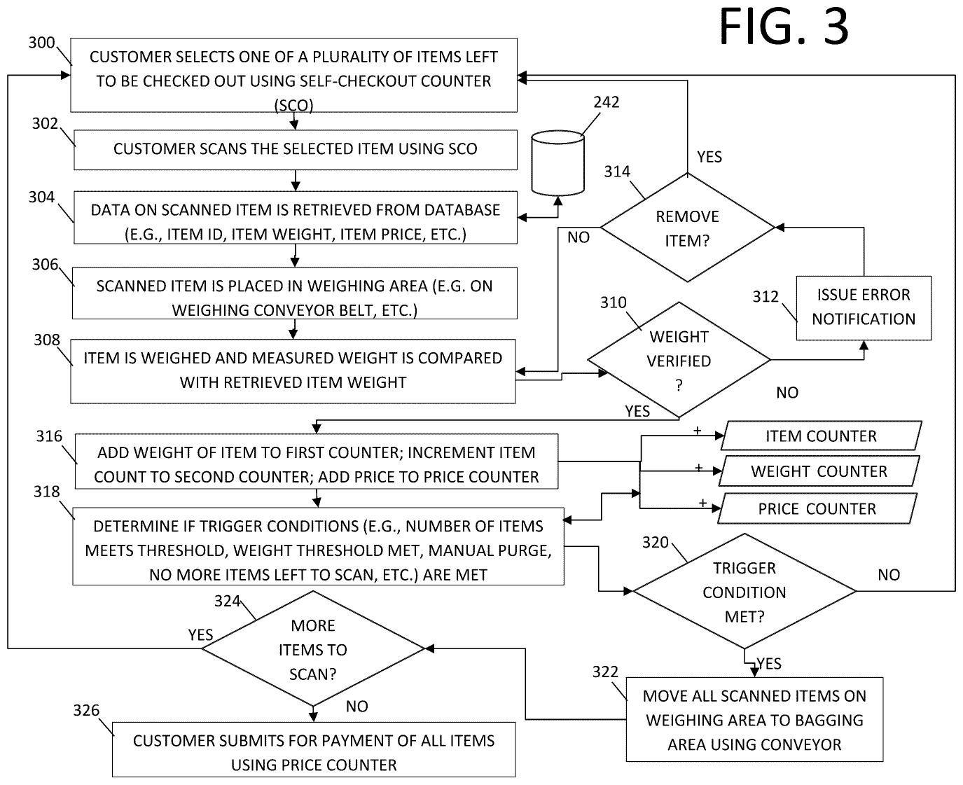

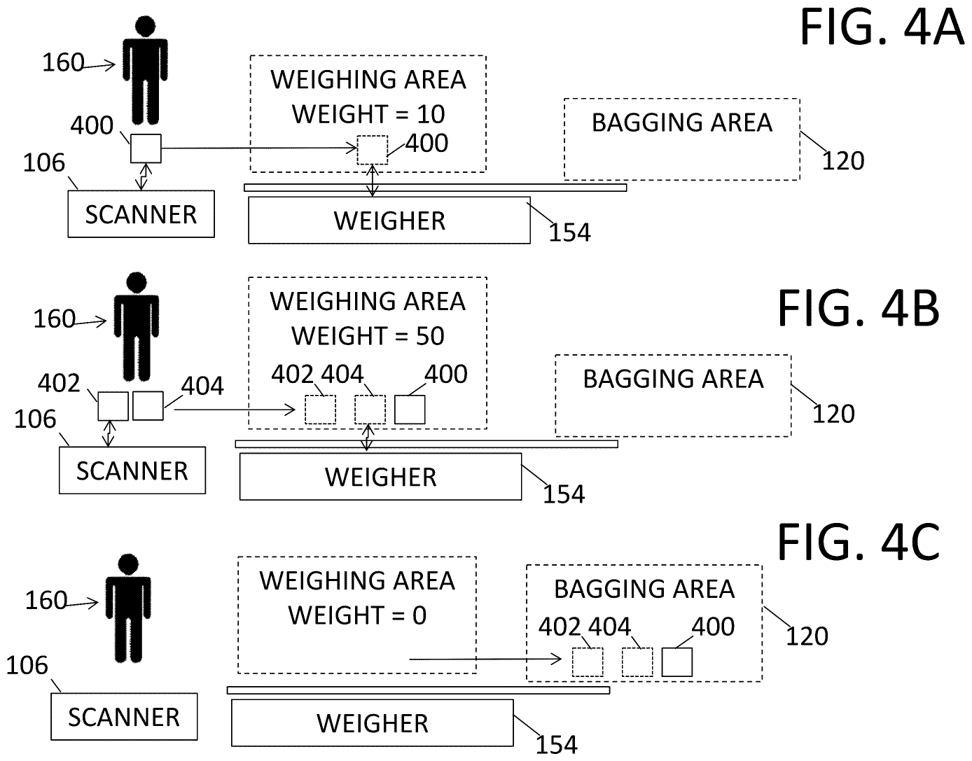

FIG. 2 illustrates a system 200 which can include the SCO 102, the central computer system 240, database(s) 242, the monitoring computer 262, and a network 250. Each of these components are discussed below in connection with the description of FIGS. 3 and 4.

Generally, in FIG. 2, the SCO 102 includes the scanner 106, display 108, and payment mechanism 109 along with an interface 212, processor 214, memory 216, conveyors 217 and a weighing system 215. The weighing system 215 includes the weighting device 154, counters (weight counter 218, price counter 220, item counter 222, etc.), a module for verifying weights (“weighting module”) 158, a module to move conveyors 226 and/or the like, according to some embodiments. The SCO 102 may be similar to the SCO 102 of FIG. 1. For example, the scanner 106 is configured to scan items electronically in order to obtain an item ID that can be used to query the database 242. The display 108 is configured to display items visually on a screen at the SCO 102, including the interfaces 212.

The interfaces 212 are configured to allow the users to input data to the SCO 102 and to display data and messages to the users. The interface 212 may be any software or hardware means to receive input from the user, such as a software graphical user interface (“GUI”) which is configured to allow a user to input data into the fields and also output data to the user. The interface 212 may be interactive to allow the user to interact with the SCO 102 via a touch screen. The interfaces 212 may be stored on the SCO 102 or remotely via the central computer system 240.

The processor 214 of the SCO 102 is configured to execute computer readable instructions stored in memory 216 to perform one or more method steps discussed in FIGS. 3 and 4. For example, the processor 204 of the SCO 102 is configured to read and execute instructions from memory 216 for the weighting module 158 to perform retrieving prestored weights of items and then weighting of the scanned items. Each of the steps discussed herein may be programmed to the SCO 102 to perform the specific steps recited herein.

The payment mechanism 109 is a device which is allowed to receive payments from the user which may be cash payments, credit card payments, or any other physical or electronic payments. The payment mechanism 109 may be connected to another network (not shown) which is configured to authenticate and approve the user's payments, such as an automated clearing house (ACH) network.

The conveyers 217 includes the entry conveyer 116, the out-feed conveyer 118, and/or any other conveyer or moving platform. The conveyers 217 may be controlled by the module to move conveyers 226. The module to move conveyers 226 is connected with the weighting module 158 and is only activated in response to receiving a command from the weighting module 158, in one embodiment.

The functioning of the SCO components are discussed more in depth with regard to FIGS. 3 and 4.

As mentioned above, the SCO 102 is communicatively connected to the central computer system 240. The central computer system 240 includes a processor 204, memory 206, a communication module 208, and a module to manage the SCO 210. These components are discussed below.

The processor 204 is configured to execute computer readable instructions stored in memory 206 to perform one or more method steps discussed herein. For example, the processor 204 of the central computer system 240 is configured, via the module to manage the SCO 210, to manage the operations of the SCO including ensuring the software of the SCO 102 is updated, recording data and transactions, ensuring the SCO is running appropriately, etc. It should be noted that any or all of the weighing system 215 may be executed by the central computer system 240 instead of or in conjunction with the SCO 102 and the present disclosure should not be limited to components of the weighing system 215 being run only on the SCO 102, as illustrated in FIG. 2. The central computer system 240 may be any computer or server that is connected to the SCO 102, the database 242, and/or the monitoring computer 262 via a network 250, such as via a LAN or WAN, via a direct wired connection, via a short-range wireless connection, and/or the like.

The communication module 208 of the central computer system 240 is configured to communicate data between the central computer system 240, the database 242, the SCO 102, and the monitoring computer 262 via the network 250. The communication module 208 is configured to access components on the central computer system 240 in combination with the processor 204 and memory 206.

The database 242 includes various items that the SCO 102 can query including item IDs 246, weights 247 of the items, and prices 248 of the items. These items 246, 247, 248 in the database 242 can be created and updated regularly via the central computer system 240.

The monitoring computer 242 is configured to monitor the second-by-second scanning by each SCO 102 attached to the monitoring computer 262. The monitoring computer 262 can be manned by an employee and connected with the SCO 102 directly or over the network 250. The monitoring computer 262 is configured to receive any error or security messages/alerts relating to the SCO 102. For example, if the user scans an item and such item's weight is not verified, the monitoring computer 262 may be notified. The monitoring computer 262 is also configured to determine if the SCO 102 is running properly, and can enable or disable one or more or all of the functions of the SCO 102.

FIG. 3 illustrates a method of checking out a plurality of items at a retailer according to various embodiments. In this regard, the SCO 102 may be located at any retailer or store that allows transactions, such a grocery stores, merchandise stores, clothing stores, and any other location which allows for a transaction to occur.

In block 300, the customer 160 selects a first item of the plurality of items to perform a transaction at the SCO 102 of the retailer. The item selected has not yet been checked out. For example, as shown in FIG. 4A, item 400 is an item that is selected among a plurality of items 400, 402, 404.

In block 302, the customer 160 scans the selected item using the scanner 106 of the SCO 102. As shown in FIG. 4A, item 400 has is being scanned by the SCO 102. The scanner 106 then will read the item ID of the first item. As mentioned above, the scanner 106 may be any device which is configured to scan the item, such as a bar code scanner, an RFID scanner, an optical scanner, a camera configured to recognize the item, or any other device to identify the item. The scanner 106 may be assisted by one or more sensors, cameras, lasers/LEDs, activators, or the like 156 to properly identify one or more features (e.g., height, weight, appearance, etc.) of the item being scanned. The scanner 106 will pull an item ID off of the item or retrieve an identifier associated with the item to obtain the item ID 244 in the database 242.

After the item has been identified and the item ID 244 is determined (using scanner or being input into the interface 212 manually), in block 304, the SCO 102 queries the database 242 with the item ID 244 to determine other data associated with the identified item, including the expected weight 246 of the item and the price 248 of the item. In this regard, the weighting module 158 will send a request to the database 242 with the item ID and the database 242 will return to the SCO the data requested including the expected weight 246 of the item and the price 248 of the item.

In block 306, the customer 160 moves the scanned item to the weighing system 158, such as by placing the item onto the entry conveyor 116 which brings the item to the weighing device 154. The scanned item will stay on the weighing device 154 until the module for moving conveyors 226 moves the item to the bagging area via the out-feed conveyor 118. The module for moving conveyors 226 is configured to move the conveyors 217 (which includes the entry conveyer 116, the out-feed conveyer 118, and/or any other conveyer or moving platform) upon receiving a command from the SCO 102, such as from the weighting module 158, from the processor, or from any other component shown in FIG. 2.

The weighting module 158 is configured to weight any of the items placed on the entry conveyor 116. The weighting module 158 will automatically be triggered when receiving the item to be measured by detecting a weight change and then measuring the actual weight of the item placed thereon. When the weight stabilizes the weighting module 158 will then register what the weight measured is, as is discussed in more depth below.

In block 308, the item is weighted (and/or measured) using the weighting module 158, and the weight of the item is then compared with the retrieved expected weight associated with the item. The weighting system 158 of the SCO 102 then, using the weighting module 158, will do this comparison and determine whether these weights match. If so, the method will continue to step 316; otherwise, the SCO 102 will issue an error notification 312 in block 312. The error notification will be transmitted to both the SCO display 108 to let the customer know of the issue as well as the monitoring computer 262 so the service attendant could be aware of the issue. The display 108 may be any type of screen configured to visually present information to the user. The display 108 may be a touch screen or other output device (e.g., audio devices) and the present disclosure should not be limited to only providing a visual output means.

In block 314, the customer 160 has an option to remove the item and start back at step 300 and to rescan an item or retry step 308 and weigh the item again. In another embodiment a new customer could start scanning instead of the same customer when the method returns to step 300.

If the comparison of weights match from steps 308, 310, the method continues to step 316 where the weight of the verified scanned item is added to a weight counter 218, in one embodiment. For example, referring to FIG. 4A, the weighing device 154 determined item 400 weighs 10 ounces, and as such the weighing counter was incremented from 0 to 10 ounces.

Additionally, in one embodiment, the number of items counter 222 scanned and weighed is incremented by one (or the number of items scanned) for the scanned verified item. For example, in FIG. 4A, when the first item 400 is scanned and the weight is verified, the item number counter 222 is incremented from 0 to 1. As shown in FIG. 4B, when items 402 and 404 are scanned, the item number counter 222 is incremented from 1 to 2 (for item 402), and then from 2 to 3 (for item 404).

Further, the price counter 220 is incremented by the retrieved price for the scanned verified item. For example, in FIG. 4A, if the first item 400 is determined from the database to be $15, the price counter 220 is incremented from 0 to $15. As shown in FIG. 4B, if the second item 402 is determined from the database to be $25, the price counter 220 is then incremented from $15 to $40. Moreover, if the third item 402 is determined from the database to be $5, the price counter 220 is then incremented from $40 to $45.

The first item scanned and weight verified will stay on the weighing device 154 as opposed to moving the item to the bagging area 120. The scanned items will stay on the weighing device 154 until a triggering condition is met. The triggering conditions may be (1) the number of items reaches a first predetermined threshold; (2) the weight of the items reaches a second predetermined threshold; (3) a manual purge signal is received; or (4) any other trigger predefined to move the items to the bagging area (such as determining the sizes of the items scanned as compared with the predefined size of the weighting area).

The first predetermined threshold and second predetermined threshold may be prestored prior to step 300 and stored in memory by a manufacturer or the retailer. The manual purge signal may be any signal received when a customer or other person manually requests the items move to the bagging area. For example, the customer 160 may press a button in the interface 212 to send the items to the bagging area, such as if the customer thinks the items in the weighting area are too big and needs to be moved to the bagging area.

In blocks 318 and 320, the weighing module 158 of the SCO 102 determines if a triggering condition is met. If not, the method returns to block 300 where the customer 160 is allowed to scan another item while the first item stays on the weighing device 154 and the conveyor above the weighing device 154. This process will continue from step 300-320. For example, as shown in FIG. 4B, item 402 was scanned, placed on the weighing device 154, and weighed, and then, item 404 was scanned, placed on the weighing device 154, and weighed. These items are shown as all being on the weighing device 154 at the same time since the triggering condition had not been met.

In FIG. 4B, the triggering condition may be that, when the weight of all of the items cumulatively on the weighing device 154 reaches 50 ounces (as determined from the weight counter 218), the system determines that the triggering condition has been met. However, if the triggering condition is that when the weight of all of the items cumulatively on the weighing device 154 reaches 100 ounces (as determined from the weight counter 218), the system determines that the triggering condition has not been met and all of the items will remain on the weighing device 154 and the next item can be immediately scanned and placed on the weighting device 154 with the other items.

If the triggering condition is met, the method moves to step 322 where all scanned items where the weight has been verified are moved using the out-feed conveyor 118 to the bagging area 120. Thus, as shown in FIG. 4C, the items 402, 404, 400 are moved using the out-feed conveyor 118 to the bagging area 120.

At this point, all counters, 218, 222 except the price counter 220 are reset to 0 so that the next set of items can be scanned and placed on the weighing device 154. The price counter 220 is not reset because the customer is still scanning more items in the customer's cart. In other words, the customer is not finished scanning items.

In block 324, the system determines if there are more items to be scanned, such as via the user interface 212 on the SCO 102. If so, the method returns to block 300 where the customer continues scanning similar to the steps as described above. If not, the customer is prompted to pay the amount determined in the price counter 220 using the payment mechanism 109.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the present disclosure is not intended to be exhaustive or to limit the present disclosure to the precise form disclosed above. While specific embodiments of, and examples for, the present disclosure are described above for illustrative purposes, various equivalent modifications are possible within the scope of the present disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the present disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference.

Aspects of the present disclosure can be modified, if necessary, to employ the systems, functions, and concepts of the various references described above to provide yet further embodiments of the present disclosure.

These and other changes can be made to the present disclosure in light of the above Detailed Description. While the above description describes certain embodiments of the present disclosure, and describes the best mode contemplated, no matter how detailed the above appears in text, the present disclosure can be practiced in many ways. Details of the system may vary considerably in its implementation details, while still being encompassed by the present disclosure disclosed herein. As noted above, particular terminology used when describing certain features or aspects of the present disclosure should not be taken to imply that the terminology is being redefined herein to be restricted to any specific characteristics, features, or aspects of the present disclosure with which that terminology is associated. In general, the terms used in the following claims should not be construed to limit the present disclosure to the specific embodiments disclosed in the specification, unless the above Detailed Description section explicitly defines such terms. Accordingly, the actual scope of the present disclosure encompasses not only the disclosed embodiments, but also all equivalent ways of practicing or implementing the present disclosure under the claims.

While certain aspects of the present disclosure are presented below in certain claim forms, the inventors contemplate the various aspects of the present disclosure in any number of claim forms. For example, while only one aspect of the present disclosure may be recited as a means-plus-function claim under 35 U.S.C sec. 112(f), other aspects may likewise be embodied as a means-plus-function claim, or in other forms, such as being embodied in a computer-readable medium. (Any claims intended to be treated under 35 U.S.C. § 112(f) will begin with the words “means for”.) Accordingly, the inventors reserve the right to add additional claims after filing the application to pursue such additional claim forms for other aspects of the present disclosure.

What is claimed is

1. A method comprising:
scanning, via a scanner, a first item;
retrieving an expected weight of the first item;
weighting, using a weighting system, the first item;
comparing the measured weight with the expected weight;
in response to the measured weight matching the expected weight:
incrementing a weight counter with the measured weight;
scanning, via the scanner, a second item while the first item remains on the weighting system;
retrieving an expected weight of the second item and adding the expected weight of the second item to the weight counter;
weighting, using the weighting system, the first and second items on the weighting system;
comparing the measured weight on the weighting system with the weight counter while the first and second item remain on the weighting system;
in response to the measured weight on the weighting system matching with the weight counter, determining if a triggering event has occurred; and
in response to determining that the triggering event has occurred, moving all items on the weighting system to a bagging area.

2. The method of claim 1, further comprising:
in response to determining that the triggering event has not occurred, allow a third item to be scanned and moved to the weighting system while the first and second items are on the weighting system.

3. The method of claim 2, further comprising:
scanning, via the scanner, the third item while the first and second items remain on the weighting system;
retrieving an expected weight of the third item and adding the expected weight of the third item to the weight counter;
weighting, using the weighting system, the first, second and third items on the weighting system;
comparing the measured weight on the weighting system with the weight counter;
in response to the measured weight on the weighting system matching with the weight counter, determining if a triggering event has occurred; and
in response to determining that the triggering event has occurred, moving all items on the weighting system to a bagging area.

4. The method of claim 1, wherein the triggering event comprises at least one of the following: (1) a number of items reaches a first predetermined threshold; (2) a total weight of the items on the weighting system reaches a second predetermined threshold; and (3) a manual purge signal is received.

5. The method of claim 1, wherein the bagging area is separate from the weighting system and a conveyer belt moves all items in the weighting system to the bagging area.

6. The method of claim 1, further comprising:
in response to the measured weight of the first item not matching the expected weight of the first item, producing an error message.

7. A non-transitory computer readable medium embodying computer program that when executed by a processor, the processor executes a method, the method comprising:
scanning, via a scanner, a first item;
retrieving an expected weight of the first item;
weighting, using a weighting system, the first item;
comparing the measured weight with the expected weight;
in response to the measured weight matching the expected weight:
incrementing a weight counter with the measured weight;
scanning, via the scanner, a second item while the first item remains on the weighting system;
retrieving an expected weight of the second item and adding the expected weight of the second item to the weight counter;
weighting, using the weighting system, the first and second items on the weighting system;
comparing the measured weight on the weighting system with the weight counter while the first and second item remain on the weighting system;
in response to the measured weight on the weighting system matching with the weight counter, determining if a triggering event has occurred; and
in response to determining that the triggering event has occurred, moving all items on the weighting system to a bagging area.

8. The non-transitory computer readable medium of claim 7, wherein the method further comprises:
in response to determining that the triggering event has not occurred, allow a third item to be scanned and moved to the weighting system while the first and second items are on the weighting system.

9. The non-transitory computer readable medium of claim 8, wherein the method further comprises:
scanning, via the scanner, the third item while the first and second items remain on the weighting system;
retrieving an expected weight of the third item and adding the expected weight of the third item to the weight counter;
weighting, using the weighting system, the first, second and third items on the weighting system;
comparing the measured weight on the weighting system with the weight counter;
in response to the measured weight on the weighting system matching with the weight counter, determining if a triggering event has occurred; and
in response to determining that the triggering event has occurred, moving all
items on the weighting system to a bagging area.

10. The non-transitory computer readable medium of claim 7, wherein the triggering event comprises at least one of the following: (1) a number of items reaches a first predetermined threshold; (2) a total weight of the items on the weighting system reaches a second predetermined threshold; and (3) a manual purge signal is received.

11. The non-transitory computer readable medium of claim 7, wherein the bagging area is separate from the weighting system and a conveyer belt moves all items in the weighting system to the bagging area.

12. The non-transitory computer readable medium of claim 7, wherein the method further comprises:
in response to the measured weight of the first item not matching the expected weight of the first item, producing an error message.

13. A system comprising:
a scanner;
a weighing system;
memory; and
a processor configured for:
scanning, via the scanner, a first item;
verifying a weight of the first item;
in response to the weight of the first item being verified:
incrementing a counter by a first amount associated with the first item;
scanning, via the scanner, a second item while the first item remains on the weighting system;
verifying a weight of the first and second items on the weighting system;
in response to the weight of the first and second items being verified, determining if a triggering event using the counter has occurred;
in response to determining that the triggering event has occurred, moving all items on the weighting system to a bagging area and resetting the counter; and
in response to determining that the triggering event has not occurred, keeping all items on the weighting system and incrementing the counter by a second amount associated with the second item.

14. The system of claim 13, further comprising:
in response to determining that the triggering event has not occurred, allow a third item to be scanned and moved to the weighting system while the first and second items are on the weighting system.

15. The system of claim 14, further comprising:
scanning, via the scanner, the third item while the first and second items remain on the weighting system;
verifying a weight of the first, second and third items on the weighting system;
in response to the weight of the first, second and third items being verified, determining if the triggering event using the counter has occurred;
in response to determining that the triggering event has occurred, moving all items on the weighting system to the bagging area and resetting the counter; and
in response to determining that the triggering event has not occurred, keeping all items on the weighting system and incrementing the counter by a third amount associated with the third item.

16. The system of claim 13, wherein the triggering event comprises at least one of the following: (1) a number of items reaches a first predetermined threshold; (2) a total weight of the items on the weighting system reaches a second predetermined threshold; and (3) a manual purge signal is received.

17. The system of claim 13, wherein the bagging area is separate from the weighting system and a conveyer belt moves all items in the weighting system to the bagging area.

18. The system of claim 13, further comprising:
in response to the measured weight of the first item not matching the expected weight of the first item, producing an error message.

19. The system of claim 13, wherein the first amount and second amount are weights of the first and second items, respectively.

20. The system of claim 13, wherein the first amount and second amount are a number of items scanned so that when an amount is added, the counter reflects an amount of items remaining on the weighting system.
